(19) United States
(12) Patent Application Publication
(10) Pub. No.: US 2024/0167902 A1
(43) Pub. Date: May 23, 2024

(54) High-resolution Graphene Heterojunction Based Pressure Sensor

(71) Applicant: Harbin Institute of Technology, Harbin (CN)

(72) Inventors: Jia ZHANG, Harbin (CN); Songlin LI, Harbin (CN); Shuai LIANG, Harbin (CN); Boxuan WU, Harbin (CN); Xinxin HE, Harbin (CN); Ping GUO, Harbin (CN)

(21) Appl. No.: 18/241,305

(22) Filed: Sep. 1, 2023

(30) Foreign Application Priority Data
Nov. 18, 2022 (CN) 202211444804.1

(51) Int. Cl. G01L 9/06

(52) U.S. Cl. CPC G01L 9/06

(57) ABSTRACT

The present disclosure provides a high-resolution graphene heterojunction based pressure sensor. The present disclosure relates to the technical field of pressure sensor design. The present disclosure uses a graphene/hexagonal boron nitride/graphene (G/h-BN/G) vertical heterojunction thin film as a pressure-sensitive diaphragm. A sensor substrate has a micro-nano arrayed concave cavity structure. Under the action of atmospheric pressure, the G/h-BN/G vertical heterojunction thin film generates localized internal stress, which changes an energy band structure of the vertical heterojunction thin film, and thus changes a tunneling current between the two upper and lower graphene layers, thereby reflecting the external atmospheric pressure changes. The principle of the graphene heterojunction based pressure sensor is based on tunneling effect. The tunneling current of the graphene heterojunction based pressure sensor is extremely sensitive to the internal stress on the heterojunction, so the sensor can achieve high-resolution detection of atmospheric pressure.

### TECHNICAL FIELD

The present disclosure relates to the technical field of pressure sensor design, and provides a high-resolution graphene heterojunction based pressure sensor.

### BACKGROUND

Pressure sensors are the core equipment for obtaining atmospheric data and pressure, and play a crucial role in the aerospace field. Their performance directly affects the operational efficiency of aerospace vehicles and even the health and safety of personnel. For example, fourth-generation fighter jets require pressure sensors to obtain accurate angles of attack during super-maneuver, otherwise, they may stall. The fighter jets require pressure sensors to accurately measure the current altitude when launching missiles, otherwise, they may cause significant hit errors. Spacesuits require pressure sensors to obtain real-time internal pressure, otherwise, a large amount of air leakage will cause fatal injuries.

Currently, commercial atmospheric pressure sensors are mainly divided into four categories based on detection principles: resonant, resistive, capacitive, and fiber optic interferometric. Each has its own advantages, but also has certain limitations. For example, resonant sensors operate based on cantilever or mass block vibration, with high accuracy and low power consumption, but have complex structures and are difficult to manufacture. Resistive sensors operate based on piezoresistive effect of materials, with good linearity, but have a relatively large temperature drift. Capacitive sensors operate based on the capacitive effect of the structure, with a relatively small temperature drift, but have significant nonlinearity in the output. Fiber optic sensors operate based on optical interference principles, can work at high temperatures, but have a large volume and low accuracy.

After nearly a century of development, commercial enterprises for producing pressure sensors represented by relevant companies from the United States, European Union, Japan, and the like have gradually emerged in the international market. For example, American General Electric Company's pressure sensors are mainly used in aerospace, meteorology, hydrology, petrochemicals, etc. Finnish Vaisala's pressure sensors are mainly used in meteorologic observation stations. For Bosch and Rohm in Germany, and TE Connectivity in Switzerland, their pressure sensors are mainly used in consumer electronics such as drones, smartphones, and home appliances. In China, there is still a large gap in pressure sensor technology compared to international giants. In the field of commercial advanced pressure sensors, core chips are heavily dependent on imports, and domestic enterprises mainly focus on circuit packaging and other related work. In the military aerospace field, small-scale specialized products have been developed by The 49^{th} Research Institute of China Electronics Technology Group Corporation, The 704^{th} Institute of China Aerospace Science and Technology Corporation, and Institute of Electronics, Chinese Academy of Sciences, but they have not yet been widely promoted and applied. A review of the research status of pressure sensors at home and abroad shows that the minimum resolution of commercial pressure sensors is about 0.01-0.05 hPa (1 hPa=100 Pa). Currently, the further improvement of sensor resolution has encountered many bottlenecks, and it is necessary to innovate detecting principles of sensors, develop new sensitive materials and structures or adopt other ways to break through the bottleneck of sensor resolution.

### SUMMARY

In order to overcome the deficiencies of the related art, the present disclosure uses a graphene/hexagonal boron nitride/graphene (G/h-BN/G) vertical heterojunction thin film as a pressure-sensitive diaphragm in combination with a micro-nano arrayed concave cavity structure of a sensor substrate, which causes localized internal stress to be generated when the atmospheric pressure acts on the pressure-sensitive diaphragm. The localized internal stress changes an energy band structure of the G/h-BN/G vertical heterojunction thin film, and thus changes a tunneling current passing through the G/h-BN/G heterojunction, thereby detecting the atmospheric pressure. The present disclosure provides a high-resolution graphene heterojunction based pressure sensor.

It should be noted that in this description, terms such as “first” and “second” are only used to distinguish one entity or operation from another, and do not necessarily require or imply any actual relationship or order between these entities or operations. Moreover, terms such as “including”, “comprising” or any other variations thereof are intended to encompass non-exclusive inclusion, so that processes, methods, articles or devices including a series of elements not only include those elements, but also include other elements not explicitly listed, or inherent elements of such processes, methods, articles or devices.

A high-resolution graphene heterojunction based pressure sensor includes: a pressure-sensitive diaphragm, an upper electrode layer, a lower electrode layer, an electrical insulation layer, a sealing layer, and a sensor substrate, where
the upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer;
the sensor substrate is provided below one electrical insulation layer, the other electrical insulation layer is provided below the sensor substrate, and the sealing layer is provided below the electrical insulation layer; and
the pressure-sensitive diaphragm is made of graphene/hexagonal boron nitride/graphene, namely G/h-BN/G vertical heterojunction thin film, and the sensor substrate adopts a micro-nano arrayed concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

Preferably, the sealing layer is made of glass, metal, polymer, or plastic.

Preferably, the concave cavity structure is a circular hole, a square hole, a polygonal hole, or an irregular hole; and

the concave cavity structure is formed by photolithography and dry or wet etching to form a large internal cavity.

Preferably, the electrical insulation layer is made of silicon oxide, silicon nitride, aluminum oxide, zirconium oxide, zinc oxide, hexagonal boron nitride, mica, PMMA, PI, or PEN.

Preferably, the upper electrode layer and the lower electrode layer are made of metal, conductive ink, or conductive polymer; and

the thickness of both the upper electrode layer and the lower electrode layer is 10-200 nanometers.

An aerospace pressure detection device is based on the high-resolution graphene heterojunction based pressure sensor.

A pressure detection device is based on the high-resolution graphene heterojunction based pressure sensor.

A high-resolution graphene heterojunction based pressure sensor includes: a pressure-sensitive diaphragm, an upper electrode layer, a lower electrode layer, an electrical insulation layer, a sealing layer, and a sensor substrate, where
the upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer;
the sensor substrate is provided below one electrical insulation layer, the other electrical insulation layer is provided below the sensor substrate, and the sealing layer is provided below the electrical insulation layer; and
the sensor substrate adopts a micro-nano single concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

An aerospace pressure detection device is based on the high-resolution graphene heterojunction based pressure sensor.

A pressure detection device is based on the high-resolution graphene heterojunction based pressure sensor.

The present disclosure has the following beneficial effects:

The present disclosure provides a high-resolution graphene heterojunction based pressure sensor, which features a novel and advanced detecting principle based on tunneling effect. The tunneling current is more sensitive to internal stress changes within thin films. Therefore, the sensor of the present disclosure surpasses resistive and capacitive pressure sensors in terms of detection resolution. Additionally, graphene has a high carrier mobility and conductivity, enabling fast transport of tunneling electrons, resulting in a response speed 2-3 orders of magnitude faster than resistive and capacitive pressure sensors, and making the sensor of the present disclosure highly advanced.

### BRIEF DESCRIPTION OF FIGURES

To describe the technical solutions in specific implementations of the present disclosure or the related art more clearly, the following briefly describes the accompanying drawings required for describing the specific implementations or the related art. Apparently, the accompanying drawings in the following description show some implementations of the present disclosure. For those of ordinary skill in the art, other drawings can be obtained according to these drawings without contributing any inventive labor.

FIG. 1 is a schematic cross-sectional view of a core sensitive structure of a graphene heterojunction based pressure sensor.

FIG. 2 is a specialized structural diagram showing materials of each part and the concave cavity structure of the sensor.

### DETAILED DESCRIPTION

The technical solutions will be described clearly and completely below in combination with the accompanying drawings. Obviously, the described embodiments are some rather than all of the embodiments. All other embodiments obtained by those of ordinary skill in the art based on the embodiments of the present disclosure without creative efforts shall fall within the scope of protection of the present disclosure.

It should be noted that in the description of the present disclosure, orientation or position relationships indicated by the terms such as “center”, “up”, “down”, “left”, “right”, “vertical”, “horizontal”, “inside”, and “outside” are based on orientation or position relationships illustrated in the accompanying drawings, and are only intended to facilitate the description of the present disclosure and simplify the description, rather than indicating or implying that the mentioned device or element must have a particular orientation or must be constructed and operated in a particular orientation. Therefore, such terms should not be construed as limitations on the present disclosure. In addition, terms such as “first”, “second”, and “third” are only used for descriptions and should not be construed as indicating or implying relative importance.

It should be noted that in the description of the present disclosure, unless otherwise specified and limited, terms such as “installation”, “connection”, and “linkage” should be understood in a broad sense. For example, they can be fixed connections, detachable connections, or integral connections; they can be mechanical connection or an electrical connection; and they can be direct connection or indirect connection through an intermediate medium, or can be internal connections between two elements. Those of ordinary skill in the art may understand the specific meanings of the foregoing terms in the present disclosure according to specific situations.

In addition, the technical features involved in the different implementations of the present disclosure described below can be combined with each other as long as they do not conflict with each other.

The following detailed description of the present disclosure is provided in conjunction with specific embodiments.

### Embodiment I

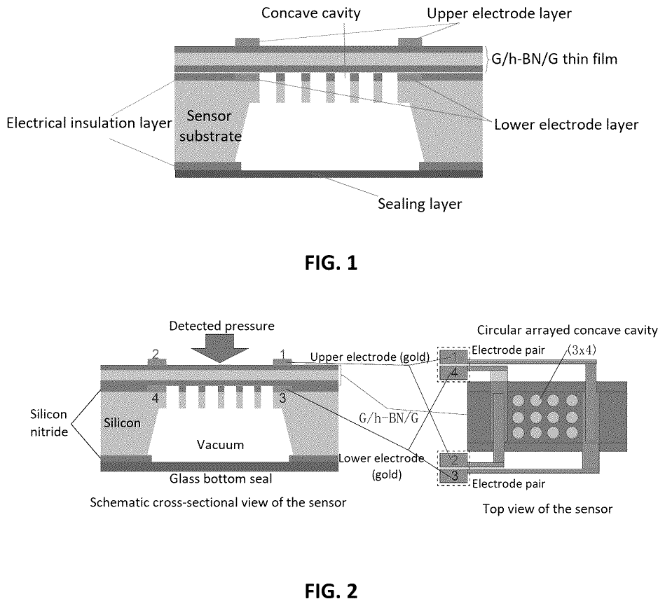

According to FIGS. 1 to 2, the specific optimized technical solution adopted by the present disclosure to solve the above technical problems is as follows: The present disclosure relates to a high-resolution graphene heterojunction based pressure sensor.

A high-resolution graphene heterojunction based pressure sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The pressure-sensitive diaphragm is made of graphene/hexagonal boron nitride/graphene, namely G/h-BN/G vertical heterojunction thin film, and the sensor substrate adopts a micro-nano arrayed concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

The main features of the sensor of the present disclosure include: 1) a graphene/hexagonal boron nitride/graphene (G/h-BN/G) vertical heterojunction thin film is used as a pressure-sensitive diaphragm, 2) a sensor substrate has a micro-nano arrayed concave cavity structure, and under the action of atmospheric pressure, the G/h-BN/G vertical heterojunction thin film generates localized internal stress, and 3) the localized internal stress changes an energy band structure of the vertical heterojunction thin film, and thus changes a tunneling current between the two upper and lower graphene layers, thereby reflecting the external atmospheric pressure changes. The principle of the graphene heterojunction based pressure sensor is based on tunneling effect. The tunneling current of the graphene heterojunction based pressure sensor is extremely sensitive to the internal stress on the heterojunction, so the sensor can achieve high-resolution detection of atmospheric pressure.

As shown in FIG. 1, the core sensitive structure of the designed pressure sensor is illustrated. From the cross-sectional view, it can be seen that from bottom to top, there are seven layers including a sealing layer, an electrical insulation layer, a sensor substrate, an electrical insulation layer, a lower electrode layer, a G/h-BN/G heterojunction thin film, and an upper electrode layer.

### Embodiment II

The only difference between Embodiment II and Embodiment I of this application lies in that:

Except the G/h-BN/G heterojunction thin film, there are a wide range of materials available for other layers, such as the sealing layer, which ensures that the cavity in the center of the sensor substrate remains in a vacuum. Therefore, the material of the sealing layer can be glass, metal, polymer, or plastic.

### Embodiment III

The only difference between Embodiment III and Embodiment II of this application lies in that:

The sensor substrate layer mainly provides support for the G/h-BN/G heterojunction thin film, and has an internal cavity and an upper micro-nano structured concave cavity. The substrate is a key component for generating localized stress in the sensor. There are a wide range of materials available for the substrate, including silicon, germanium, various metals, and polymers. The micro-nano structured concave cavity on the substrate can be a single structure, an array of the same structure, or an array of different structures. The concave cavity structure can be a circular hole, a square hole, a polygonal hole, or an irregular hole.

The electrical insulation layers on upper and lower sides of the sensor substrate mainly serve to isolate the electrical signals and can choose various insulating materials such as silicon oxide, silicon nitride, aluminum oxide, zirconium oxide, zinc oxide, hexagonal boron nitride, mica, and various polymers (PMMA, PI, PEN).

After the assembly of the sensitive structure of the sensor is completed, a pressure difference is formed on upper and lower sides of the G/h-BN/G vertical heterojunction thin film, causing the G/h-BN/G vertical heterojunction thin film to bend downward on the concave cavity structure, thereby generating stress within the thin film.

Under the action of the arrayed concave cavity structure, an arrayed stress distribution is generated at different positions in the thin film, thereby changing the energy band structure of the G/h-BN/G vertical heterojunction thin film.

The energy band structure of the G/h-BN/G vertical heterojunction thin film directly determines the tunneling transport behavior of electrons between the hexagonal boron nitride layers, which is macroscopically manifested as the magnitude of the tunneling current. Therefore, a relationship model between the external atmospheric pressure and the tunneling current can be established.

When the external atmospheric pressure increases, the degree of downward bending of the G/h-BN/G vertical heterojunction thin film increases, the internal stress within the thin film increases, and the tunneling current increases. Conversely, when the external atmospheric pressure decreases, the degree of downward bending of the G/h-BN/G vertical heterojunction thin film decreases, the internal stress within the thin film decreases, and the tunneling current decreases. Therefore, a relationship model between the magnitude of the external atmospheric pressure and the magnitude of the tunneling current can be established.

Compared with the resistive and capacitive pressure sensors, the detecting principle based on tunneling effect in the present disclosure is novel and advanced. The tunneling current is more sensitive to internal stress changes within thin films. Therefore, the sensor of the present disclosure surpasses resistive and capacitive pressure sensors in terms of detection resolution. Additionally, graphene has a high carrier mobility and conductivity, enabling fast transport of tunneling electrons, resulting in a response speed 2-3 orders of magnitude faster than resistive and capacitive pressure sensors, and making the sensor of the present disclosure highly advanced.

### Embodiment IV

The only difference between Embodiment IV and Embodiment III of this application lies in that:

The electrical insulation layer is made of silicon oxide, silicon nitride, aluminum oxide, zirconium oxide, zinc oxide, hexagonal boron nitride, mica, PMMA, PI, or PEN.

### Embodiment V

The only difference between Embodiment V and Embodiment IV of this application lies in that:

The upper and lower electrode layers mainly serve the function of electrical signal conduction, and their structural forms are diverse, which can be various shapes. The selected electrode materials are also diverse, such as various metals, conductive inks, and conductive polymers.

The thickness of both the upper electrode layer and the lower electrode layer is 10-200 nanometers.

### Embodiment VI

The only difference between Embodiment VI and Embodiment V of this application lies in that:

The present disclosure provides an aerospace pressure detection device based on the high-resolution graphene heterojunction based pressure sensor. The sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The pressure-sensitive diaphragm is made of graphene/hexagonal boron nitride/graphene, namely G/h-BN/G vertical heterojunction thin film, and the sensor substrate adopts a micro-nano arrayed concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

### Embodiment VII

The only difference between Embodiment VII and Embodiment VI of this application lies in that:

The present disclosure provides a pressure detection device based on the high-resolution graphene heterojunction based pressure sensor. The sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The pressure-sensitive diaphragm is made of graphene/hexagonal boron nitride/graphene, namely G/h-BN/G vertical heterojunction thin film, and the sensor substrate adopts a micro-nano arrayed concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

### Embodiment VIII

The only difference between Embodiment VIII and Embodiment VII of this application lies in that:

The present disclosure provides a high-resolution graphene heterojunction based pressure sensor. The sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The sensor substrate adopts a micro-nano single concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

### Embodiment IX

The only difference between Embodiment IX and Embodiment VIII of this application lies in that:

The present disclosure provides an aerospace pressure detection device based on the high-resolution graphene heterojunction based pressure sensor. The sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The sensor substrate adopts a micro-nano single concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

### Embodiment X

The only difference between Embodiment X and Embodiment IX of this application lies in that:

The present disclosure provides a pressure detection device based on the high-resolution graphene heterojunction based pressure sensor. The sensor includes: a pressure-sensitive diaphragm, an upper electrode layer, a lower electrode layer, an electrical insulation layer, a sealing layer, and a sensor substrate.

The upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer.

The sensor substrate is provided below one electrical insulation layer, the other electrical insulation layer is provided below the sensor substrate, and the sealing layer is provided below the electrical insulation layer.

The sensor substrate adopts a micro-nano single concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

### Embodiment XI

The only difference between Embodiment XI and Embodiment X of this application lies in that:

As shown in FIG. 2, materials of each part and the concave cavity structure of the sensor are specialized.

1. The sealing substrate is glass, which is vacuum-bonded to the sensor substrate for sealing and forms an internal vacuum seal with the sensor substrate.

2. The sensor substrate is a silicon substrate, on which a micro-nano structured concave cavity array is formed by photolithography and dry etching on the upper part, and a large internal cavity is formed by photolithography and wet etching on the lower part.

3. The electrical insulation layers on upper and lower sides of the sensor substrate are silicon nitride, which is grown on both sides of the silicon wafer by thermal oxidation. Silicon nitride can be used as an anti-etching layer for the concave cavity by dry etching and internal cavity by wet etching, and can also be used as an electrical insulation layer in subsequent device construction.

4. The G/h-BN/G vertical heterojunction thin film can be formed into a heterojunction thin film by layer-by-layer transfer, or it can be directly grown and then transferred as a whole. The thickness of the thin film is about 5-10 nanometers, and the thickness of the upper and lower layers of graphene is 1-2 nanometers, while the thickness of the middle boron nitride is 4-8 nanometers.

5. The upper and lower electrodes are made of gold and prepared by photolithography and coating.

With one of the above specific implementation plans, the manufacturing of graphene heterojunction based pressure sensors can be realized. The sensor works by applying atmospheric pressure to the G/h-BN/G vertical heterojunction thin film, where the pressure difference between the external atmospheric pressure and the pressure inside the silicon cavity causes the G/h-BN/G vertical heterojunction thin film to bend downwards and generate localized stress within the thin film under the circular concave cavity structure. This stress changes the electron tunneling current between the upper and lower layers of graphene, thereby establishing a relationship between the external atmospheric pressure and the tunneling current. By further changing the external atmospheric pressure, the internal stress within the G/h-BN/G vertical heterojunction thin film changes, and thus the tunneling current changes. This enables the graphene heterojunction based sensor to detect pressure. In addition, due to the high sensitivity of the tunneling current to internal stress within the G/h-BN/G vertical heterojunction thin film and the fast carrier mobility in graphene, which is 1-2 orders of magnitude higher than that of silicon, the G/h-BN/G vertical heterojunction thin film can respond to even small changes in pressure, thereby achieving high-resolution pressure detection.

In this description, the description of the reference terms “an embodiment”, “some embodiments”, “an example”, “a specific example”, “some examples” and the like means that specific features, structures, materials or characteristics described in combination with the embodiment(s) or example(s) are included in at least one embodiment or example of the present disclosure. In this description, the exemplary expressions of the above terms do not necessarily refer to the same embodiments or examples. Besides, the specific features, the structures, the materials or the characteristics that are described may be combined in proper manners in any one or N embodiments or examples. In addition, a person skilled in the art may integrate or combine different examples or examples described in this description and features of the different embodiments or examples as long as they are not contradictory to each other. In addition, terms “first” and “second” are used merely for the purpose of description, and shall not be construed as indicating or implying relative importance or implying a quantity of indicated technical features. Therefore, a feature restricted by “first” or “second” may explicitly or implicitly include at least one of such features. In the description of the present disclosure, unless otherwise specifically defined, “a plurality of” means at least two, such as two and three. Any process or method described in a flowchart or otherwise may be understood as a module, fragment, or portion of code including one or N executable instructions for implementing custom logic functions or processes, and the scope of the preferred examples of the present disclosure includes additional implementations where the steps may be executed in a different order than shown or discussed, including executing functions in a fundamentally simultaneous manner or in reverse order based on the functionality involved, as understood by those skilled in the art to which the embodiments of the present disclosure belongs. The logical and/or steps represented in a flowchart or otherwise described herein, for example, may be considered an ordered list of executable instructions for implementing logical functions, which may be specifically implemented in any computer-readable medium for use by an instruction execution system, device, or device (such as a computer-based system, including a processor-based system, or other system capable of fetching and executing instructions), or in combination with such instruction execution systems, device, or devices. For the purposes of this description, a “computer-readable medium” may be any device that can contain, store, communicate, propagate, or transport programs for use by an instruction execution system, device, or device, or in combination with such instruction execution systems, device, or devices. More specific examples of computer-readable media (non-exhaustive list) include devices with one or N wired electrical connections (electronic devices), portable computer disk boxes (magnetic devices), a random access memory (RAM), a read-only memory (ROM), an erasable programmable read-only memory (EPROM or flash memory), fiber optic devices, and a portable CD-ROM read-only memory. Further, computer-readable media may even include paper or other suitable media on which the program is printed, as the program may be obtained electronically, for example, by optical scanning of the paper or other media, followed by editing, interpretation, or other appropriate processing to obtain the program in electronic form, which may then be stored in computer memory. It should be understood that the various parts of the present disclosure may be implemented using hardware, software, firmware, or a combination thereof. In the above implementations, N steps or methods may be implemented using software or firmware stored in memory and executed by a suitable instruction execution system. For example, if implemented in hardware, any of the following techniques known in the field or combinations thereof may be used, as in another implementation, including discrete logic circuits with logic gates for implementing logical functions on data signals, dedicated integrated circuits with suitable combinations of logic gates, programmable gate arrays (PGA), field programmable gate arrays (FPGA), and the like.

Those skilled in the art may understand that all or part of the steps carried out by the above embodiments may be accomplished by programming related hardware, and the program may be stored in a computer-readable storage medium, which, when executed, includes one or a combination of the steps of the method embodiment. In addition, functional units in the embodiments of the present disclosure may be integrated into one processing module, or each of the units may be physically separated, or two or more units may be integrated into one module. The integrated module may be implemented in the form of hardware, or may be implemented in the form of a software functional module. When the integrated module is implemented in the form of the software functional module and sold or used as an independent product, the integrated unit may also be stored in a computer-readable storage medium.

The above description is only a preferred implementation of a high-resolution graphene heterojunction based pressure sensor. The scope of protection of the high-resolution graphene heterojunction based pressure sensor is not limited to the above embodiments, and any technical solution under this concept belongs to the scope of protection of the present disclosure. It should be noted that for those skilled in the art, various improvements and changes without departing from the principle of the present disclosure should also be considered within the scope of protection of the present disclosure.

What is claimed is:

1. A high-resolution graphene heterojunction based pressure sensor, comprising: a pressure-sensitive diaphragm, an upper electrode layer, a lower electrode layer, an electrical insulation layer, a sealing layer, and a sensor substrate, wherein
the upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer;
the sensor substrate is provided below one electrical insulation layer, the other electrical insulation layer is provided below the sensor substrate, and the sealing layer is provided below the electrical insulation layer; and
the pressure-sensitive diaphragm is made of graphene/hexagonal boron nitride/graphene (G/h-BN/G) vertical heterojunction thin film, and the sensor substrate adopts a micro-nano arrayed concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

2. The high-resolution graphene heterojunction based pressure sensor according to claim 1, wherein the sealing layer is made of glass, metal, polymer, or plastic.

3. The high-resolution graphene heterojunction based pressure sensor according to claim 2, wherein the concave cavity structure is a circular hole, a square hole, a polygonal hole, or an irregular hole; and
the concave cavity structure is formed by photolithography and dry or wet etching to form a large internal cavity.

4. The high-resolution graphene heterojunction based pressure sensor according to claim 3, wherein the electrical insulation layer is made of silicon oxide, silicon nitride, aluminum oxide, zirconium oxide, zinc oxide, hexagonal boron nitride, mica, polymethyl methacrylate (PMMA), polyimide (PI), or poly(ethylene naphthalate (PEN).

5. The high-resolution graphene heterojunction based pressure sensor according to claim 4, wherein the upper electrode layer and the lower electrode layer are made of metal, conductive ink, or conductive polymer; and
the thickness of both the upper electrode layer and the lower electrode layer is 10-200 nanometers.

6. An aerospace pressure detection device, comprising the high-resolution graphene heterojunction based pressure sensor according to claim 1.

7. A pressure detection device, comprising the high-resolution graphene heterojunction based pressure sensor according to claim 1.

8. A high-resolution graphene heterojunction based pressure sensor, comprising: a pressure-sensitive diaphragm, an upper electrode layer, a lower electrode layer, an electrical insulation layer, a sealing layer, and a sensor substrate, wherein
the upper electrode layer is provided on each side of a top layer of the pressure-sensitive diaphragm, the lower electrode layer is provided on each side of a bottom layer of the pressure-sensitive diaphragm, and the electrical insulation layer is provided on each outer side of the lower electrode layer;
the sensor substrate is provided below one electrical insulation layer, the other electrical insulation layer is provided below the sensor substrate, and the sealing layer is provided below the electrical insulation layer; and
the sensor substrate adopts a micro-nano single concave cavity structure, which causes localized internal stress to be generated when the atmospheric pressure acts on the pressure-sensitive diaphragm, and the localized internal stress changes an energy band structure of the G/h-BN/G vertical heterojunction thin film, and thus changes a tunneling current passing through the G/h-BN/G heterojunction, thereby detecting the atmospheric pressure.

9. An aerospace pressure detection device, comprising the high-resolution graphene heterojunction based pressure sensor according to claim 8.

10. A pressure detection device, comprising the high-resolution graphene heterojunction based pressure sensor according to claim 8.
